(19) United States
(12) Patent Application Publication
(10) Pub. No.: US 2010/0140839 A1
(43) Pub. Date: Jun. 10, 2010

(54) LIGHTWEIGHT MOULDED PIECE AND CORRESPONDING PRODUCTION METHOD

(75) Inventors: Otto Huber, Gangkofen (DE); Hubert Klaus, Ergolding (DE)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: Fachhochschule Landshut, Herm Huber (DE)

(21) Appl. No.: 12/516,292

(22) PCT Filed: Nov. 8, 2007
(86) PCT No.: PCT/EP2007/062086

§ 371 Date: Feb. 25, 2010

(30) Foreign Application Priority Data
Nov. 28, 2006 (DE) 10 2006 056 167.8

(51) Int. Cl. B32B 3/26

(52) U.S. Cl. 264/279.1; 428/313.9; 428/304.4

(57) ABSTRACT

The present invention provides a lightweight moulded part and a corresponding production method. The lightweight moulded part comprises a core region (1) made of a lightweight composite material (10, 15) which comprises a matrix material (15) and at least one filler material (10); at least one surface or near-surface cover layer region (2a, 2b) which comprises at least one layer of fibre material (5) and the matrix material (15); the layer (or layers) of fibre material (5) of the cover layer region (2a, 2b) being integrated into the matrix material (15) of the core region (1).

### PRIOR ART

The present invention relates to a lightweight moulded part and a corresponding production method.

Lightweight materials and moulded parts are nowadays used in many technical fields, such as automotive engineering, aircraft construction and shipbuilding, and in transport in general. They are distinguished by their high rigidity, strength and energy absorption capacity as well as a low density by comparison with conventional construction materials, and allow economical production of highly loaded construction elements. Lightweight materials with a density below 1.0 kg/dm³, and of which the density lies below that of most current plastics materials, are of particular interest.

Conventional lightweight moulded parts, such as sandwich structures with a light honeycomb core, generally cannot be produced curved. It is generally only possible to produce sandwich elements with a single curve when using sandwich cores which are produced by folding paper or metal (thin sheets) or as wave constructions.

This can be rectified with cores which may consist of cellular materials or cellular composite materials made of syntactic foam, and which also allow sandwich elements with a plurality of curves to be produced. In conventional cellular materials, the shear strength is very low by comparison with the compression strength. This is a disadvantage for sandwich constructions, which are generally subjected to shear force.

In cellular composite materials (for example mineral foam granules in a polyamide matrix), the ratio of shear strength to compression strength is typically 0.6. The corresponding value for aluminium foams for example is only 0.15. On this point, see Rausch G. et al., Foaminal® —Eigenschaftsübersicht—Konstruktionsrichtlinien—Version 1.8, Fraunhoferinstitut für Fertigungstechnik and angewandte Materialforschung, 2005. For this reason, sandwich structures with cellular composite materials as a core material have great potential for use in lightweight construction. The full potential cannot be tapped when using cover layers which are adhesively bonded or laminated on, because damage (delamination) often sets in in the connection layer between the core and the cover layer during use. FIG. 7 shows the results of three-point flexural tests on sandwich beams with adhesively bonded (polyurethane adhesive) or integrated cover layers. The cores consist of cellular composite materials with glass foam granules which are embedded in the acrylic resin. Integrating the cover layer increases the strength of the sandwich beam by up to 200% by comparison with the sandwich beams with adhesively bonded cover layers.

The object of the present invention is to provide an improved lightweight moulded part and a corresponding production method with which a stronger and more stable lightweight moulded part can be produced.

The invention provides the lightweight moulded part specified in claim 1 and the production method specified in claim 11.

The present invention makes it possible to eliminate the adhesion or lamination process in the sandwich production procedure and thus to make full use of the potential of the lightweight core material in lightweight construction, for example a cellular composite material or another syntactic foam, and to achieve economical production.

The present invention is based on the idea of eliminating the process of adhesively bonding or laminating the core and one or more surface or near-surface cover layers by integrating cover layer production into the core production process.

The invention provides sandwich elements consisting of a core made of a lightweight composite material with one or more integrated reinforcing cover layers. The sandwich elements may be narrow (sandwich beams) or wide (sandwich panels). They may be planar or curved (one or more times). Furthermore, a novel type of lightweight composite profile with open profile cross-sections or with closed (single-cell or multi-cell) hollow cross-sections, which consist of a core made of a lightweight composite material with an integrated reinforced outer layer and optionally also an integrated reinforced inner layer, are also made possible.

In the present document, lightweight composite material is generally understood to mean a material which comprises a matrix material and at least one light filler material. The light composite materials for the cores of the sandwich elements according to the invention or lightweight composite profiles according to the invention may be cellular composite materials, such as plastics-bonded or metal-bonded lightweight composite materials based on mineral foam granules, as disclosed for example in EP 1 188 730 A2 and EP 0 851 808 B1. Cellular lightweight composite materials based on metal foam granules or composite materials consisting of hollow spheres or hollow microspheres (glass, ceramics or metal) in a plastics material or metal matrix or other syntactic foams, such as syntactic foams based on mineral foam granules, are also possible.

Polyamides, acrylates or other plastics materials, with the monomers or polymer viscosity selected in accordance with the filler material (for example <0.1-5 Pa), may also preferably be used as a matrix material. Light metal melts such as aluminium or zinc melts may be used to produce a metal matrix. The proportion of light foam granule or hollow spheres by volume (including the volume of the hollow spaces in the hollow spheres) may be up to 60% of the total sandwich volume. The foam granules or hollow spheres can have diameters between 0.5 mm and 16 mm, depending on the sandwich thickness. Typical diameter fractions (conventional particle-size distribution curves) are (1-2 mm), (2-4 mm) and (4-6 mm). The density of the foam granules is conventionally between 0.1 kg/dm³ and 1.0 kg/dm³. Typical densities of the hollow spheres are 0.1 kg/dm³ to 0.9 kg/dm³.

The fibres of the single-layer or multilayer fibre construction may be arranged unidirectionally or in different directions. The thickness of the cover layer region in which the fibre material is integrated into the matrix material of the core region is conventionally between 2% and 12% of the thickness of the sandwich construction as a whole.

The sandwich elements according to the invention in the form of lightweight composite profiles are distinguished by high flexural rigidity and high strength at a low weight. As well as simple sandwich shapes, such as straight beams and planar plates, complex shapes such as curved beams and frames which are curved one or more times can be produced. By comparison with sandwich elements with cores made of conventional cellular materials (pure metal or plastics material foams), the sandwich elements according to the invention with cellular lightweight composite materials have a relatively high shear strength because of the special granule, sphere or hollow sphere construction. Instability problems, such as buckling or crumpling of the cover layers, can be avoided or shifted to higher levels of force by the integral construction. The high specific compression and shear rigidity and strength reduce the compression of the cover layers when subjected to compression and shear forces. The novel type of construction is therefore advantageous for local applications of force. In the novel lightweight composite profiles, distortion can be avoided by virtue of the supporting effect of the core material and the quality of the lightweight construction can thus be improved. As well as completely filled profiles, hollow profiles with closed and open cross-sections can be produced. Furthermore, the sandwich elements and lightweight composite profiles according to the invention have advantageous energy absorption and sound absorption characteristics because of the cellular (predominantly closed-pored) structure thereof.

With the method according to the invention, sandwich elements made of cellular composite materials with integrated reinforced layers and lightweight composite profiles with a supporting core made of cellular composite materials and integrated reinforced cover layers can be produced. The solid and inextensible cover layer required for sandwich elements and lightweight composite profiles is produced integrally within the core production process.

Subsequent connection (for example adhesion) of the cover layers for the transfer of the tension/compression forces and shear forces is not required. The corner covers, edge protection, attachments and reinforcements which are necessary in sandwich constructions for force applications or for support may also be integrated into the production process as disclosed.

The disclosed sandwich elements are advantageously used in lightweight constructions which support a shear force flexural load. These may for example be flooring or cargo bay flooring in aircraft, buses, boats, ships or automobiles. In vans or pickup trucks, the loading platforms and driving cab rear walls may advantageously be formed with the disclosed sandwich construction. In the field of construction, the disclosed sandwich elements may be used for double floors (upper floors for example in computer rooms) or as lightweight partition walls, lightweight cover elements, or doors and gates. In aircraft construction or shipbuilding, partitions (for example pressure domes) may be produced in the form of a sandwich element with the disclosed construction. In automotive engineering, the disclosed sandwich construction may for example be used in the undercarriage as the floor of the boot or for the backrest of the back row of seats. The backrest for the back seats may be divided (for example one third to two thirds), which causes a very high shear force flexural load, in particular if a three-point seatbelt is to be used for the middle seat. Another high shear force load is produced in a crash if a heavy piece of luggage from the boot collides with the backrest of the back seats. In this case, the high energy absorption of the disclosed sandwich elements is important as well as the high flexural rigidity and flexural strength. This advantage also applies to the use of a sandwich element in the region of the rear wall of a van, lorry or caravan (protecting the passengers from the cargo in the case of a crash).

The disclosed sandwich elements enable lightweight moulded parts for the leisure industry, such as skateboards, skis or snowboards to be produced with more favourable mechanic and acoustic properties, in particular as regards impulsive loads (for example noise protection for skateboarding in residential areas). A further field of application is the furniture industry. In this case, the sandwich elements can be used as light, rigid and strong tabletops or work surfaces (for example in kitchens and workshops).

At least one lateral cover layer region in the form of an edge band or edge protection or corner protection may preferably be provided on the lightweight moulded part.

At least one force application element (local reinforcement of the core region) may preferably be provided on the lightweight moulded part.

At least one structural component attachment (centre or corner attachment) may preferably be provided on the lightweight moulded part.

The disclosed lightweight composite profiles can be used advantageously in lightweight constructions which are subjected to shear force flexural loading and/or compression loading. In this case, the light support core prevents buckling of the lightweight structure. Thus, a higher quality of lightweight construction may be achieved than with thin-walled monostructures or completely filled profiles of the same weight. The disclosed lightweight composite profiles can be used as crash elements (for example a crash box in the front region of a passenger vehicle or in the front region of commercial vehicles) to improve the passive safety of the passenger vehicle or commercial vehicle.

Advantageous developments and improvements of the lightweight moulded part specified in claim 1 and of the production method specified in claim 14 are to be found in the sub-claims.

### DRAWINGS

Embodiments of the invention are shown in the drawings and will be explained in greater detail in the following description.

In the drawings:

FIG. 1 is a schematic cross-sectional view of a lightweight moulded part according to a first embodiment of the present invention;

FIG. 2 is a schematic cross-sectional view of a lightweight moulded part in the form of a hollow profile according to a second embodiment of the present invention;

FIGS. 3a)-d) are schematic perspective views illustrating a production method for a lightweight moulded part according to a third embodiment of the present invention;

FIG. 4 is a perspective view illustrating a modified mould for the production method for a lightweight moulded part according to the third embodiment of the present invention;

FIGS. 5a)-c) are schematic perspective views illustrating a production method for a lightweight moulded part according to a fourth embodiment of the present invention;

FIG. 6 is a perspective view illustrating a mould for a production method for a lightweight moulded part according to a fifth embodiment of the present invention; and

FIG. 7 shows the results of a three-point flexural test on sandwich beams with adhesively bonded and integrated cover sheets respectively.

### DESCRIPTION OF THE EMBODIMENTS

In the figures, like reference numerals indicate identical or functionally identical elements.

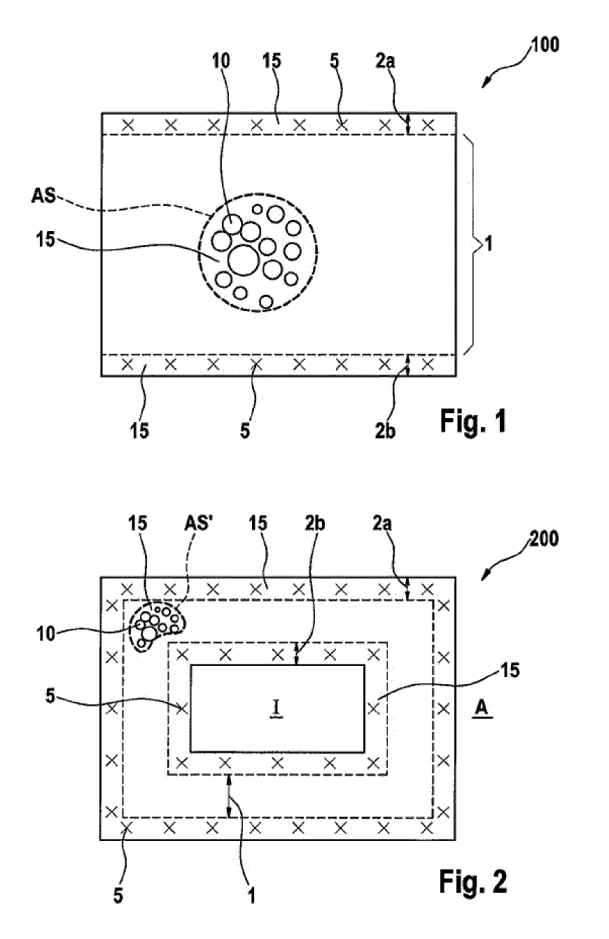

FIG. 1 is a schematic cross-sectional view of a lightweight moulded part according to a first embodiment of the present invention.

In FIG. 1, reference numeral 100 denotes a lightweight moulded part made of a lightweight composite material 10, 15 which comprises a matrix material 15 and a filler material 10. In the present example, the filler material 10 consists for example of hollow spheres or foam granules with a diameter of between 4 mm and 6 mm, whereas the matrix material is a cured polyamide-based plastics material. To simplify the drawing, FIG. 1 only shows a portion AS, enclosed by a dashed line, of the core region 1. Moreover, the lightweight moulded part 100 comprises a first upper surface cover layer region 2a and a second lower surface cover layer region 2b, each of which comprises a fibre material 5 which is integrated into the matrix material 15 of the core region. In this case, the dashed line in FIG. 1 represents a virtual boundary of the core region up to which the filler material 10 extends. Because of the diameter of the filler material 10 and the fibre material 5, no filler material 10 is present in the cover layer region 2, and the matrix material 15 alone extends in one piece all the way from the core region 1 into the cover layer region 2.

A single surface cover layer region 2a or 2b or further additional lateral cover layer regions would of course also be possible.

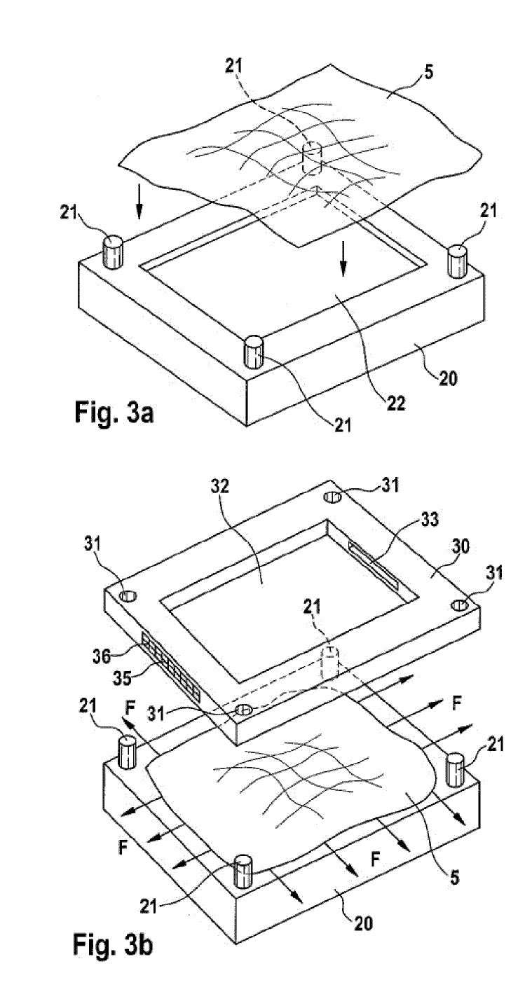

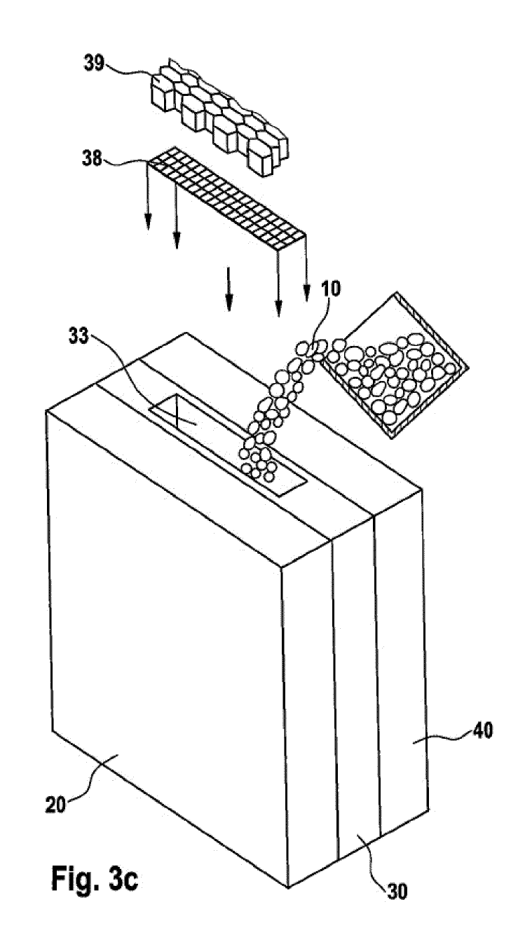

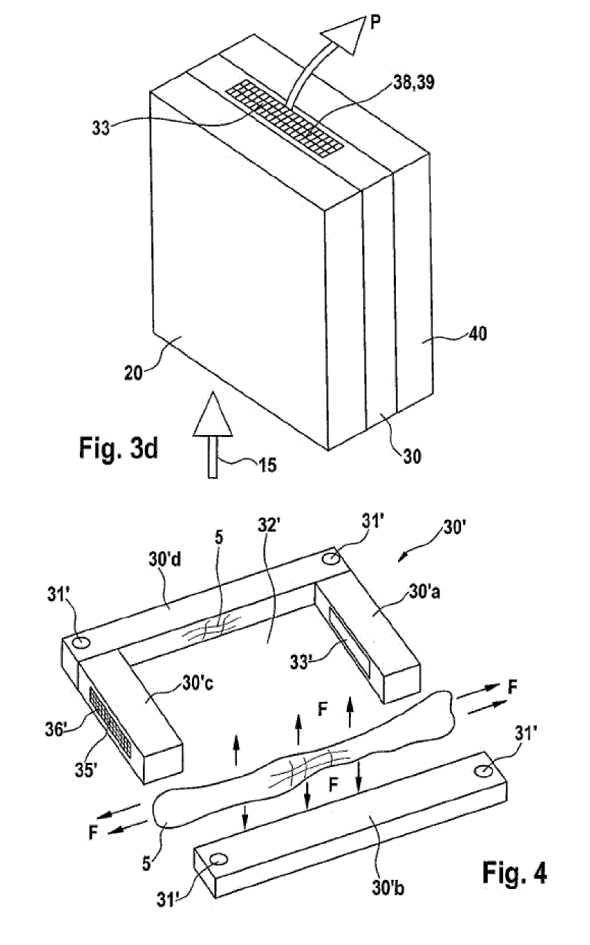

The sandwich-type lightweight moulded part 100 of FIG. 1 is in this example a narrow or wide, planar or curved element with a quadrilateral cross-section. It is provided with its particular shape in a production process which is explained further below with reference to FIG. 3a)-d).

FIG. 2 is a schematic cross-sectional view of a lightweight moulded part in the form of a hollow profile according to a second embodiment of the present invention.

The lightweight moulded part 200 according to FIG. 2 is in the form of a hollow profile, i.e. a tubular configuration, the reference A denoting an exterior and the reference I denoting an interior of the tube. In this embodiment, an external fibre-reinforced cover layer region 2a is provided as a boundary for the exterior A and an internal fibre-reinforced cover layer region 2b is provided as a boundary for the interior I. The core region 1 corresponds, as is shown in the detail AS′, to the core region of the lightweight moulded part in FIG. 1.

A single surface cover layer region 2a or 2b or further additional end face cover layer regions would of course also be possible.

FIGS. 3a)-d) are schematic perspective views illustrating a production method for a lightweight moulded part according to a third embodiment of the present invention;

In FIG. 3a), reference numeral 20 denotes a mould part in the form of a mould lid with a central recess 22 and alignment pins 21. In a first process step, the required layer or layers of fibre material 5 (for example non-woven materials, bands, knitted materials, knitted fabrics, bonded materials or woven materials made of carbon, glass, aramid or metal fibres or other fibres) for a first cover layer region are applied to a horizontally positioned mould part 20, the layer or layers of the fibre material 5 being tightened over the recess 22. The recess 22 typically has a constant depth of 0.1 to 0.5 mm so as to allow good covering of the layer of fibre material 5 with the matrix material which is to be introduced later.

Continuing with reference to FIG. 3b), the layer or layers of fibre material 5 are tightened in the direction of the arrow F, and a stentering frame 30 in an annular configuration is attached, with a central through-hole 32, alignment holes 31, a filling opening 33 for the filler material and a gate 35 for the matrix material with integrated grating 36 and with a cover lid (not shown) which can be applied.

Optionally, one or more bleeders may be laid between the horizontally positioned mould part 20 and the layer or layers of fibre material 5.

The filling opening 33 for the filler material later also subsequently serves as an extraction or de-airing opening when pouring the matrix material. The grating 36 integrated into the gate 35 acts to hold back the filler material which is to be added later (for example granule or hollow spheres). The cover lid which is to be applied completely seals the relevant side of the stentering frame before the filler material is added. The filling opening 33 can be attached to suction means.

The stentering frame 30 is attached in such a way that the alignment pins 21 of the mould part 20 are introduced into the alignment holes 31 of the stentering frame 30 and the two parts are pressed together. The stentering frame 30 which is placed on and pressed against the mould part 20 can be connected more securely thereto by suitable clamping connections (not shown) (for example clips, clamps or screws), so that the biasing of the layer of fibre material 5 is maintained for the rest of the mounting process.

After the optional application and tightening of a further layer of fibre material on a further mould part 40 in the form of a mould lid, which is identical to the mould part 20 disclosed above, the second mould part 40, which is provided depending on the use of a further layer or further layers of fibre material either with or without a recess, is placed on the stentering frame 30 from the other side, pressed thereagainst, and clamped, and this takes place analogously to the connection of the mould part 20 to the stentering frame 30.

After the assembly of the complete mould consisting of the mould parts 20 and 40 and the stentering frame 30 clamped between them, as shown in FIG. 3c), the filler material is poured into the complete mould through the upwardly aligned filling opening 33. In the present example, the filler material 10 consists of hollow spheres (for example glass, metal or ceramic) or foam granules. The filling process may be promoted for example by tilting or shaking. When the complete mould 20, 30, 40 is completely filled, a further grating 38 (analogous to the grating in the gate 35) is inserted into the filling opening 33, and after this a support honeycomb 39 is inserted into the filling opening 33.

The grating 38 and the support honeycomb 39 are provided to compensate the lifting forces which occur during infiltration and/or to compensate the pressures which occur in the die-casting process. In a subsequent process step, the filling opening 33 is attached to a vacuum pump P or covered with a ventilation lid.

Subsequently, the liquid matrix material 15 is introduced from below (to avoid bubble formation) via the gate 35 through the grating 36. Filling the mould 20, 30, 40 with the matrix material 15 causes the film consisting of the filler material 10 and the layer or layers of the fibre material 5 to be infiltrated with the matrix material, which is for example a casting polyamide or a multi-component acrylic resin or another organic system or a metal melt.

The matrix material 15 is subsequently polymerised and solidified.

After the matrix material 15 has completely solidified, the demoulding and finishing processes—optionally cutting to shape or polishing away the projecting fibre material 5—take place.

Fibre material projecting at the sides can also be avoided by appropriate trimming or folding, or with a stitching process before the moulding process (fixing via a positive or material connection also being possible). The problem of projecting fibres can also be solved with the subsequent application of an edge band with a near-net-shape sandwich panel. When producing large sandwich panels, smaller panels can be sawn therefrom in such a way that fibres projecting at the sides are also thereby removed.

For cost-efficient production of the sandwich elements, the above process steps may be automated by using robots or hydraulic systems.

FIG. 4 is a perspective view illustrating a modified mould for the production method for a lightweight moulded part according to the third embodiment of the present invention.

In the embodiment shown in FIG. 4, a multi-part stentering frame 30′ with alignment holes 31′ and a central through-hole 32′ is used instead of the single-part stentering frame 30 of FIG. 3b). The multipart stentering frame 30′ contains four lateral parts 30′a, 30′b, 30′c and 30′d, which are rigidly interconnected via clamping connections (not shown).

As is shown in FIG. 4, a multipart stentering frame 30′ of this type allows layers of fibre material 5 to be integrated into the lateral faces of the subsequent sandwich construction, which layers act for example as edge protection for the sandwich construction. The clamping connection may also be produced using clips or screws.

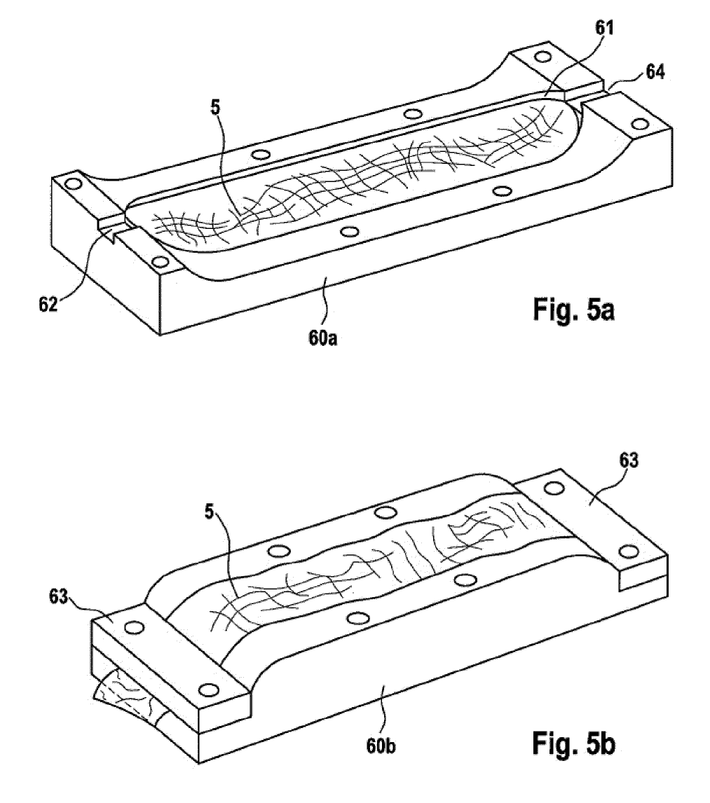

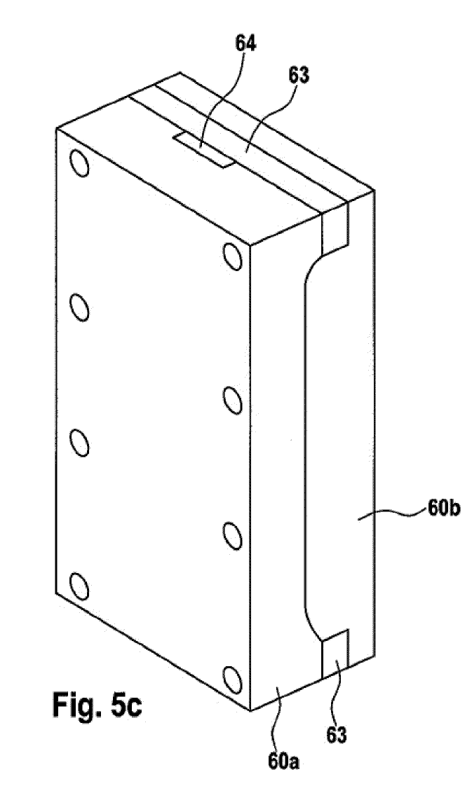

FIGS. 5a)-c) are schematic perspective views illustrating a production method for a lightweight moulded part according to a fourth embodiment of the present invention.

In particular, FIG. 5a)-c) show a specific example application of the method explained in detail with reference to FIG. 3a)-d), namely the production of a moulded part for a skateboard or snowboard.

With reference to FIG. 5a), a lower mould half 60a is prepared, comprising a recess 61 which corresponds to the later sandwich thickness of the skateboard. Analogously to the complete mould of FIG. 3a)-d), the lower mould part 60a comprises a gate 62 and a filling opening 64. A first layer of fibre material 5 is laid in the recess 61. The first layer of fibre material 5 can be tightened mechanically or using an adhesive. Optionally, a layer of fibre material may be applied as an edge band or edge protection on the edges of the depression 61.

In FIG. 5b), a second mould half 60b is prepared, on which a layer of fibre material 5 for the upper cover layer of the skateboard is prepared, which layer can be clamped using clamping blocks 63. Optionally, the upper mould half 60b may also comprise a depression for the layer of fibre material 5 so as to allow the fibre construction to be thoroughly covered by the matrix material.

After the preparation of the two mould halves 60a, 60b of FIGS. 5a) and 5b), the upper mould half 60b is rotated through 180° and placed in the correct alignment on the lower mould half 60a and rigidly connected thereto by screwing for example. After the assembly of the complete mould 60a, 60b, as shown in FIG. 5c), the filler material 10 can be added via the filling opening 64, and subsequently the matrix material 15 may be introduced from below via the gate 62, as was described in detail in relation to FIG. 3a)-d).

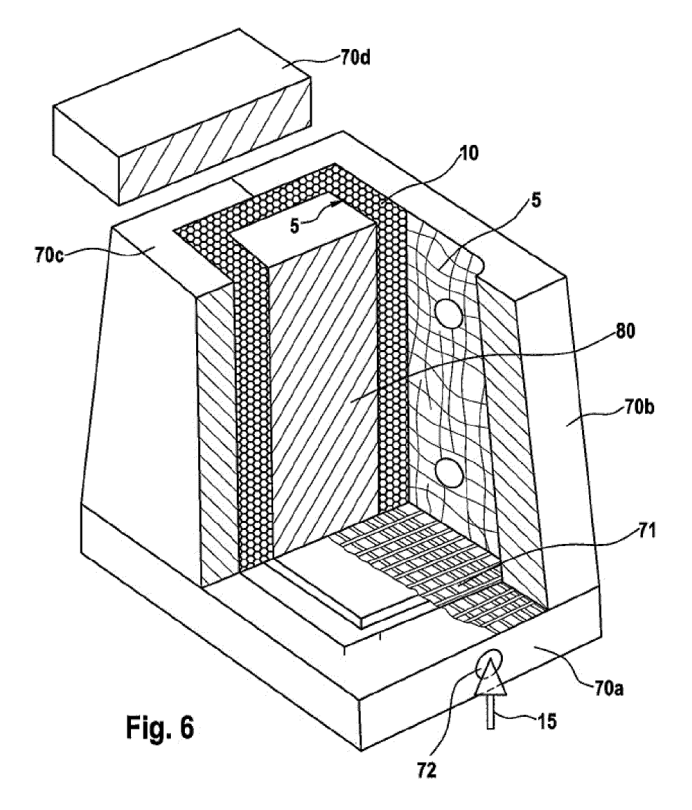

FIG. 6 is a perspective view illustrating a mould for a production method for a lightweight moulded part according to a fifth embodiment of the present invention.

The production process for a lightweight moulded part in the form of a hollow profile according to FIG. 2 is explained in greater detail with reference to FIG. 6.

First, the outer layer of fibre material 5 is applied, tightened and fixed to the walls of the mould halves 70b, 70c, which are attached to a mould base plate 70a. The mould halves 70b, 70c are only shown in part in the drawing of FIG. 6 and are actually provided on the mould base plate so as to extend all the way around.

Furthermore, an inner layer of fibre material 5 may be attached to a casting core 80 and the casting core is mounted on the mould base plate 70a. In this way, a hollow profile is produced between the mould halves 70b, 70c and the casting core.

After the casting core 80 is mounted, the hollow profile is filled with the filler material 10, for example mineral foam or glass foam or metal foam granules, and this may be promoted by shaking in. Subsequently, the upper face of the mould 70a, 70b, 70c shown in FIG. 6 is sealed with a grating (not shown), an optional perforated intermediate plate and a cover lid 70d with vacuum suction means. The mould 70a, 70b, 70c, 70d is then filled from below with liquid matrix material, for example plastics material (monomers or polymers) or metal, in such a way that the filler material 10 and the inner and outer layer of fibre material 15 are infiltrated. The air is allowed to escape through an opening in the outlined cover lid 70d and by means of the vacuum pump attached thereto. The integrated grating and the optional perforated intermediate plate in this case act to fix the filler material 10 in order to counteract the lifting forces or pressures of the die-casting method.

After polymerisation or solidification, the demoulding, including extraction of the core, and finishing process (optionally trimming the projecting fibres) take place.

For simpler extraction of the casting core 80 (thermal contraction of the cast part during cooling) said core may optionally be made so as to be split. A lost core may also be used. Lost cores may for example be shaken out, melted out or washed out.

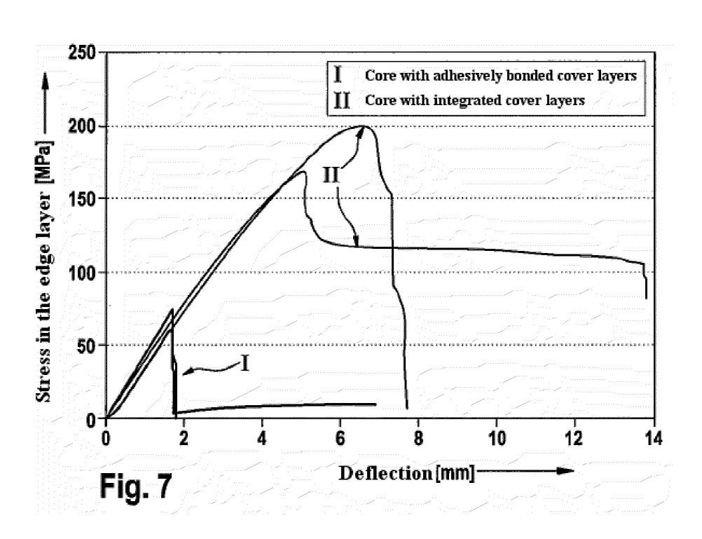

FIG. 7 shows three-point flexural tests on sandwich beams with adhesively bonded (the two lines marked I) and integrated cover layers (the two lines marked II). The cores consist of cellular composite materials with glass foam granules which are embedded in acrylic resin. Integrating the cover layer increases the strength of the sandwich beam by up to 200% by comparison with sandwich beams with adhesively bonded cover layers.

Although the present invention was described above by way of preferred embodiments, it is not limited to these but can be modified in numerous ways.

Although only one or two cover layer regions have been shown in the embodiments described above, a lightweight moulded part according to the invention may comprise any desired number of cover layer regions or be completely surrounded by a single cover layer region.

1. Lightweight moulded part comprising:
a core region (1) made of a lightweight composite material (10, 15) and comprising a matrix material (15) and at least one filler material (10);
at least one surface or near-surface cover layer region (2a, 2b) which comprises at least one layer of fibre material (5) and the matrix material (15);
wherein the layer or layers of fibre material (5) of the cover layer region (2a, 2b) are integrated into the matrix material (15) of the core region (1); and
wherein the lightweight composite material (10, 15) is a cellular composite material, bonded by a plastics material matrix material or bonded by a metal matrix material, with mineral foam granules or glass foam granules or metal foam granules as a filler material (10).

2. Lightweight moulded part according to claim 1, wherein the fibre material (5) comprises a band or a non-woven material or a woven material or a bonded material or a knitted fabric or a knitted material.

3. Lightweight moulded part according to claim 1 wherein the fibre material (5) comprises at least one of the following fibre types: glass fibres, carbon fibres, aramid fibres, metal fibres.

4. Lightweight moulded part according to claim 1, which comprises a single-cell or multi-cell closed profile or an open profile.

5. Lightweight moulded part according to claim 4, which comprises a tubular profile, wherein a first outer cover layer region (2a) and/or a second inner cover layer region (2b) are provided.

6. Lightweight moulded part according to claim 1, wherein the proportion of the filler material (10) by volume, including internal hollow spaces of the filler material (10), is between 40% and 60%.

7. Lightweight moulded part according to claims 1, wherein the proportion of the filler material (10) by volume, including internal hollow spaces of the filler material (10), is between 30% and 50%.

8. Lightweight moulded part according to claim 1, wherein the filler material (10) is only present in the core region (1).

9. Lightweight moulded part according to claim 1, wherein the filler material (10) is present in the core region (1) and also in the cover layer region (2).

10. Production method for a lightweight moulded part with the following steps:
preparing a mould (20, 30, 40; 60a, 60b; 70a, 70b, 70c, 70d) with a hollow space corresponding to the outer contours of the lightweight moulded part which is to be produced;
applying at least one layer of a fibre material (5), corresponding to a surface or near-surface cover layer region (2a, 2b) of the lightweight moulded part which is to be produced, in the hollow space of the mould (20, 30, 40; 60a, 60b; 70a, 70b, 70c, 70d);
shaking a filler material (10) of mineral foam granules or glass foam granules or metal foam granules into the hollow space of the mould (20, 30, 40; 60a, 60b; 70a, 70b, 70c, 70d);
filling the hollow space of the mould (20, 30, 40; 60a, 60b; 70a, 70b, 70c, 70d) with a curable liquid matrix material (15) in such a way that the layer or layers of the fibre material (5) and the fill consisting of the filler material (10) are infiltrated;
curing the matrix material (15), the layer or layers of fibre material (5) of the cover layer region (2a, 2b) being integrated into the matrix material (15) of the core region (1), leading to the formation of the lightweight moulded part; and
demoulding the formed lightweight moulded part.

11. Production method for a lightweight moulded part according to claim 10, wherein the mould (20, 30, 40; 60a, 60b; 70a, 70b, 70c, 70d) is in a plurality of parts and the least one layer of a fibre material (5) is applied before the mould (20, 30, 40; 60a, 60b; 70a, 70b, 70c, 70d) is assembled.

12. Production method for a lightweight moulded part according to claim 10, wherein the mould (20, 30, 40; 60a, 60b; 70a, 70b, 70c, 70d, 80) comprises a first and a second opening (33, 35; 33′, 35′; 62, 64), one of which is used for filling the hollow space with the filler material (10) and the other of which is used for filling the hollow space with the matrix material (15).

13. Production method for a lightweight moulded part according to claim 10, wherein a casting core (80) which corresponds to the inner contours of the lightweight moulded part to be produced is introduced into the hollow space of the mould (70a, 70b, 70c, 70d).

14. Production method for a lightweight moulded part according to claim 13, wherein at least one layer of a fibre material (5) which corresponds to a further surface or near-surface cover layer region (2a, 2b)) of the lightweight moulded part to be produced is applied on the casting core (80).

15. Production method for a lightweight moulded part according to claim 10, after the demoulding process, a finishing process takes place in the form of trimming or grinding away projecting fibre material (5).

16. Production method for a lightweight moulded part according to claim 10, wherein hollow microspheres are mixed into the liquid matrix material (15) before filling.

17. Production method for a lightweight moulded part according to either 14, wherein no macroscopic granules or hollow spheres are used.

18. Production method for a lightweight moulded part according to claim 10, wherein one or more bleeders are positioned between the mould (20, 30, 40; 60a, 60b; 70a, 70b, 70c, 70d , 80) and the layer or layers of fibre material (5).

19. Lightweight moulded part according to claim 1, wherein at least one lateral cover layer region is provided in the form of an edge band or edge protection or corner protection.

20. Lightweight moulded part according to claim 1, wherein at least one force application element is provided.

21. Lightweight moulded part according to claim 1, wherein at least one structural component attachment is provided.

22. Production method for a lightweight moulded part according to claim 14, wherein one or more bleeders are positioned between the mould (20, 30, 40; 60a, 60b; 70a, 70b, 70c, 70d , 80) and the layer or layers of fibre material (5).

23. Lightweight moulded part according to claim 1, wherein at least one lateral cover layer region is provided in the form of an edge band or edge protection or corner protection.

24. Lightweight moulded part according to claim 1, wherein at least one force application element is provided.

25. Lightweight moulded part according to claim 1, wherein at least one structural component attachment is provided.
